(19) United States
(12) Patent Application Publication
(10) Pub. No.: US 2015/0241728 A1
(43) Pub. Date: Aug. 27, 2015

(54) DISPLAY DEVICE

(71) Applicant: Sharp Kabushiki Kaisha, Osaka (JP)

(72) Inventor: Masayuki Hata, Osaka (JP)

(73) Assignee: Sharp Kabushiki Kaisha, Osaka (JP)

(21) Appl. No.: 14/422,046

(22) PCT Filed: Aug. 22, 2013
(86) PCT No.: PCT/JP2013/072381

§ 371 Date: Feb. 17, 2015

(30) Foreign Application Priority Data
Aug. 31, 2012 (JP) 2012-192163

(51) Int. Cl. G02F 1/1343; G02F 1/1333; G06F 3/044

(52) U.S. Cl. CPC G02F 1/13439; G06F 3/044; G02F 1/13338; G06F 2203/04111

(57) ABSTRACT

The present invention provides a touch panel-equipped display device in which the transmittance of the display device is maintained and occurrence of the moiré effect is reduced without having to change the design of the touch panel or display panel. The present display device includes: a display panel provided with a black matrix having a plurality of mutually parallel straight members; a touch panel having a plurality of mutually parallel wires; and an interference sheet having a repeating structure that includes a plurality of mutually parallel repeating units. The interference sheet is disposed between the touch panel and the display panel, and the relationship A<C<B is satisfied by the spacing A between adjacent straight members in the black matrix, the spacing B between adjacent wires in the touch panel, and the spacing C between adjacent repeating units of the interference sheet.

### TECHNICAL FIELD

The present invention relates to a display device. More particularly, the present invention relates to a display device provided with a touch panel and a display panel.

### BACKGROUND ART

In recent years, display devices have been equipped with touch panels in order to enhance their usability as information systems. Large touch panels typically employ optical schemes based on infrared light or the like, but capacitive touch panels have also been researched. In capacitive touch panel applications, mesh type touch panels in which fine metal wires are disposed in a mesh pattern are used, for example.

In multilayer display devices provided with a mesh type touch panel and a display panel, the fine metal wires in the touch panel are arranged in a regular pattern, and the black matrix or the like in the display panel also forms a regular pattern. Placing these regular patterns on top of one another creates interference, resulting in the so-called moiré effect (patterns of interference). Moire patterns can significantly impair the viewing characteristics of a display device.

One known method of mitigating this issue is to set the angle of the direction in which a regular pattern is formed (the “regular pattern formation direction”) on an optical sheet to the regular pattern formation direction of the pixels in the display panel such that occurrence of the moiré effect is reduced. Setting the pitch of the pixel pattern in the display panel and the pitch of the mesh wiring pattern in the touch panel in such a way as to minimize the spacing between moiré fringes has also been investigated (see Patent Document 1, for example).

### RELATED ART DOCUMENT

### Patent Document

Patent Document 1: Japanese Patent Application Laid-Open Publication No. 2000-206529

### SUMMARY OF THE INVENTION

### Problems to be Solved by the Invention

As display devices have become thinner in recent years, these display devices have been designed with an increasingly small distance between the touch panel and display panel, making occurrence of the moiré effect more likely. While the abovementioned methods can reduce occurrence of the moiré effect, the angle of the regular pattern formation direction of the touch panel wiring to the regular pattern formation direction of the pixels in the display panel (that is, the regions surrounded by the black matrix); the pitches of the regular patterns; or the like must be set individually for each display device. As a result, when a display panel with a different pixel pattern is used in a display device, the touch panel must also be redesigned, thereby making standardization more difficult.

Moreover, the number of pixels used in display devices is increasing in order to achieve ever higher resolutions, and increasingly complex pixel patterns are used to improve viewing angle characteristics. Meanwhile, in touch panels that have regular patterns such as mesh type touch panels or the like, there are currently limits on design of the pitch of the regular patterns formed by wiring due to problems related to manufacturability and performance. As a result, changing the design of touch panels in consideration of display panel characteristics such as the number of pixels or the pixel pattern so as to reduce occurrence of the moiré effect is difficult.

Furthermore, even if the pitch of each regular pattern or the angle of the regular pattern formation direction of the touch panel wiring to the regular pattern formation direction of the pixels in the display panel could be set to values that would reduce occurrence of the moire effect, any small misalignments during the manufacturing process would again result in occurrence of the moiré effect.

The present invention was made in view of such problems, and aims to provide a touch panel-equipped display device in which the transmittance of the display device is maintained and visibility of moiré patterns is reduced without having to change the design of the touch panel or display panel.

### Means for Solving the Problems

The inventor researched methods for reducing the occurrence of the moiré effect, focusing in particular on reducing visibility of moiré patterns by reducing moiré pitch (the spacing between adjacent interference fringes in a moiré pattern). Moreover, as the inventor continued this research, they found that by inserting an interference sheet having a prescribed repeating structure of mutually parallel repeating units into a display device to change the manner in which the interference manifested, they could reduce the moiré pitch of the resulting moiré patterns in comparison with before the interference sheet was added. Although the moire effect still occurs when using this method, the resulting moiré patterns are less visible because the moiré pitch is reduced, and the overall moiré effect is less perceptible to the viewer.

The inventor also found that if the spacing between adjacent repeating units on the interference sheet is too small, the transmittance of the display device decreases drastically. Finally, the inventor found that it is possible to reduce the visibility of moiré patterns while maintaining the transmittance of the display device by making the spacing between the repeating units of the interference sheet inserted in the display device wider than the spacing between adjacent straight members in the black matrix but smaller than the spacing between adjacent wires in the touch panel.

The inventor predicted that this could effectively solve the abovementioned problems and arrived at the present invention.

In other words, one aspect of the present invention is a display device, including: a display panel including a black matrix that has a plurality of straight sections parallel to one another; a touch panel having a plurality of wiring lines parallel to one another; and an interference sheet having a plurality of repeating sections parallel to one another, wherein the interference sheet is disposed between the touch panel and the display panel, and wherein <#1> formula (1) A<C<B is satisfied when A is spacing between adjacent straight sections of the black matrix, B is spacing between adjacent wiring lines of the touch panel, and C is spacing between adjacent repeating sections of the interference sheet.

<#1>

A<C<B (1)

The present display device may, as appropriate, include any other components conventionally used in display devices as long as the abovementioned required components are included.

Examples of the abovementioned display panel include liquid crystal display (LCD) panels, electroluminescent (EL) display panels, plasma display panels, and the like.

Examples of touch panels having a plurality of mutually parallel wires within the display region include mesh type touch panels, stripe type touch panels, and any other type of touch panels typically employed in capacitive touch panel applications.

Providing the interference sheet changes the manner in which interference occurs, allowing the visibility of moiré patterns to be reduced by reducing the moiré pitch thereof.

If the spacing C between adjacent repeating units of the interference sheet is too small, the transmittance of the display device decreases drastically. Therefore, using an interference sheet that satisfies formula (1) above allows the visibility of moiré patterns to be reduced while maintaining the transmittance of the display device.

The plurality of repeating units of the interference sheet can be formed using light-shielding members, for example. Examples of light-shielding members include members made from metals such as copper (Cu), iron (Fe), and titanium (Ti), as well as from other materials such as resins that contain a black pigment.

The plurality of repeating units on the interference sheet can be formed of a transparent base material, for example. Examples of transparent base materials include resin films having a high transparency such as polyethylene terephthalate (PET) or triacetylcellulose (TAC), as well as glass or the like.

Examples of repeating structures that can be used for the interference sheet include structures that exhibit the following forms when viewed in a plan view: (a) a stripe pattern, and (b) a grid pattern. The repeating structure (a) can reduce the visibility of moiré patterns that occur when other stripe patterns are present, and the repeating structure (b) can reduce the visibility of moiré patterns that occur when other grid patterns are present.

Examples of the repeating structure (b) having a grid pattern when viewed in a plan view include structures that include a plurality of mutually parallel first repeating units and a plurality of mutually parallel second repeating units that intersect the first repeating units.

### Effects of the Invention

The present invention provides a touch panel-equipped display device in which the transmittance of the display device is maintained and visibility of moiré patterns is reduced without having to change the design of the touch panel or display panel.

### BRIEF DESCRIPTION OF THE DRAWINGS

FIG. 1 is a cross-sectional view schematically illustrating a display device according to Embodiment 1.

FIG. 2 is a perspective view schematically illustrating the display device according to Embodiment 1.

FIG. 3 is a cross-sectional view schematically illustrating an interference sheet that can be used in Embodiment 1.

FIG. 4 is a cross-sectional view schematically illustrating an interference sheet that can be used in Embodiment 1.

FIG. 5 is a cross-sectional view schematically illustrating an interference sheet that can be used in Embodiment 1.

FIG. 6 is a plan view schematically illustrating an interference sheet (or the wiring of a touch panel or the black matrix of a liquid crystal panel) that can be used in Embodiment 1.

FIG. 7 is a plan view schematically illustrating an interference sheet (or the wiring of a touch panel or the black matrix of a liquid crystal panel) that can be used in Embodiment 1.

FIG. 8 is a plan view schematically illustrating an interference sheet (or the wiring of a touch panel or the black matrix of a liquid crystal panel) that can be used in Embodiment 1.

FIG. 9 is a plan view schematically illustrating an interference sheet (or the wiring of a touch panel or the black matrix of a liquid crystal panel) that can be used in Embodiment 1.

FIG. 10 is a perspective view schematically illustrating an interference sheet that can be used in Embodiment 1.

FIG. 11 is a perspective view schematically illustrating an interference sheet that can be used in Embodiment 1.

FIG. 12 is a perspective view schematically illustrating an interference sheet that can be used in Embodiment 1.

FIG. 13 is a cross-sectional view schematically illustrating a display device according to Embodiment 2.

FIG. 14 is a cross-sectional view schematically illustrating a display device according to Embodiment 3.

FIG. 15 is a cross-sectional view schematically illustrating a display device X as envisioned for a simulation.

FIG. 16 is a cross-sectional view schematically illustrating a display device Y as envisioned for a simulation.

FIG. 17 is a graph showing the results of the simulation for display device X.

FIG. 18 is a graph showing the results of the simulation for display device Y.

### DETAILED DESCRIPTION OF EMBODIMENTS

Embodiments of the present invention will be explained in detail below with reference to figures. However, the present invention is not limited only to these embodiments.

### Embodiment 1

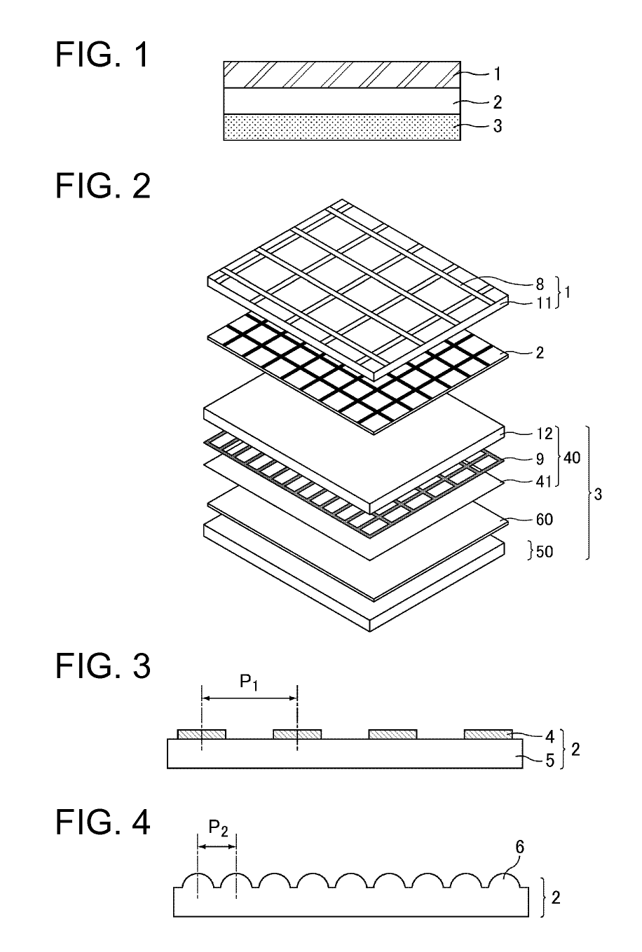

FIG. 1 is a cross-sectional view schematically illustrating a display device according to Embodiment 1. FIG. 2 is a perspective view schematically illustrating the display device according to Embodiment 1. In Embodiment 1, a touch panel 1, an interference sheet 2, and a display panel 3 are disposed in this same order from the side from which the display device is viewed to the rear surface of the display device, as shown in FIG. 1. An example of Embodiment 1 in which a capacitive touch panel is used for the touch panel 1 and a liquid crystal panel is used for the display panel 3 will be described below with reference to FIG. 2. However, Embodiment 1 is not limited to this example.

As shown in FIG. 2, the capacitive touch panel 1 includes: a transparent substrate 11 made of a material such as glass or a resin, and a plurality of wires 8 formed on the transparent substrate 11 for the purpose of detecting static electricity. The plurality of wires 8 may be made from a transparent material or from a light-shielding material. Moreover, the plurality of wires 8 are formed in a prescribed regular pattern, but the overall group of wires formed by the plurality of wires may take the form of a stripe pattern or a grid pattern.

The display panel 3 includes a first substrate 40 (a color filter substrate), a second substrate 50 (an array substrate), and a liquid crystal layer 60 interposed between the first substrate 40 and the second substrate 50. The first substrate 40 includes, in order from the side from which the display device is viewed, a transparent substrate 12 made of a material such as glass or a resin, a black matrix 9, and a color filter 41. The second substrate 50 includes a transparent substrate, thin film transistors (TFTs), data signal lines, scan signal lines, pixel electrodes, and the like. The black matrix 9 is formed to block light in areas of the display region that should not allow light to pass through, and can be formed to surround each pixel, for example. Moreover, the black matrix 9 is formed in a prescribed regular pattern, but the overall black matrix may take the form of a stripe pattern or a grid pattern.

The interference sheet 2 will be described in detail below. FIGS. 3 to 5 are cross-sectional views schematically illustrating interference sheets that can be used in Embodiment 1. FIGS. 6 to 9 are plan views schematically illustrating interference sheets that can be used in Embodiment 1. The plurality of repeating units of the interference sheet 2 may each be: (i) formed using light-shielding members, or (ii) formed by shaping a transparent base material. In case (i), the black areas in FIGS. 6 to 9 correspond to repeating units formed using light-shielding members, while in case (ii), the white areas in FIGS. 6 to 9 correspond to repeating units formed by shaping a transparent base material.

Examples of case (i) include a plurality of repeating units that appear as shown in FIG. 3 when viewed in cross-section. In the case of the plurality of repeating units shown in FIG. 3, a plurality of repeating units (light-shielding units) 4 are formed using light-shielding members formed on a transparent base material 5. In this type of interference sheet 2, when the light-shielding members are made from a metal (such as Cu or Ag), they can be fabricated on the transparent base material 5 using vapor deposition, photolithoetching, or the like. When the light-shielding members are made from a resin, they can be fabricated by printing a light-shielding material containing a black pigment such as carbon on the transparent base material 5.

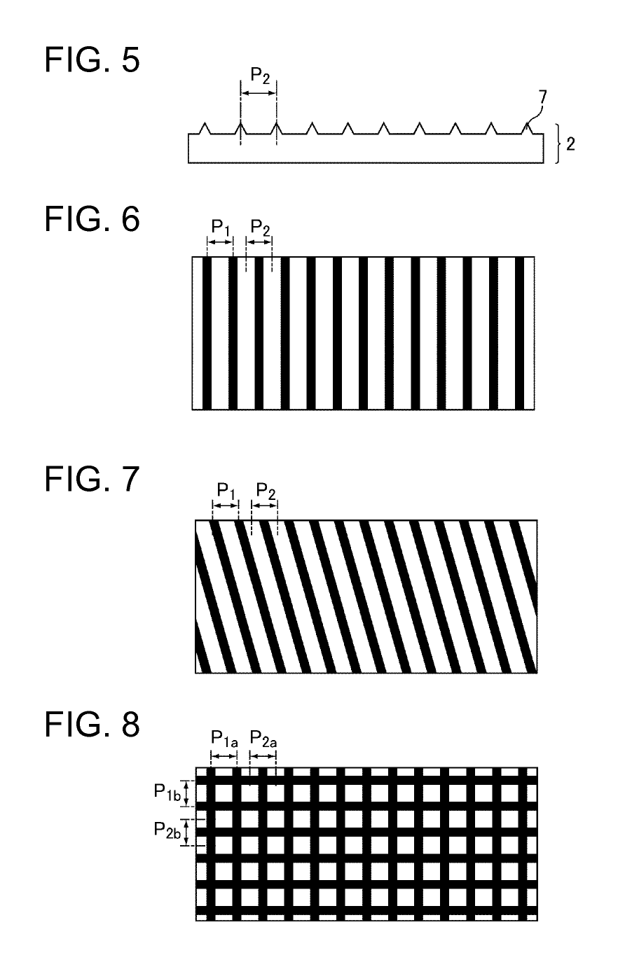

Examples of case (ii) include a plurality of repeating units that appear as shown in FIG. 4 or 5 when viewed in cross-section. In the case of the plurality of repeating units shown in FIG. 4, a plurality of hemispherical protrusions 6 are formed of the transparent base material. This type of interference sheet 2 having a plurality of repeating units can be fabricated by injection molding a resin such as acrylic or polycarbonate (PC). Meanwhile, in the case of the plurality of repeating units shown in FIG. 5, a plurality of pointed protrusions 7 are formed in a sawtooth pattern by shaping the transparent base material. This type of interference sheet 2 having a plurality of repeating units can be fabricated by injection molding a resin such as acrylic or polycarbonate (PC). Moreover, a commercially available lens sheet of the type used in a backlight can also be used as the interference sheet 2.

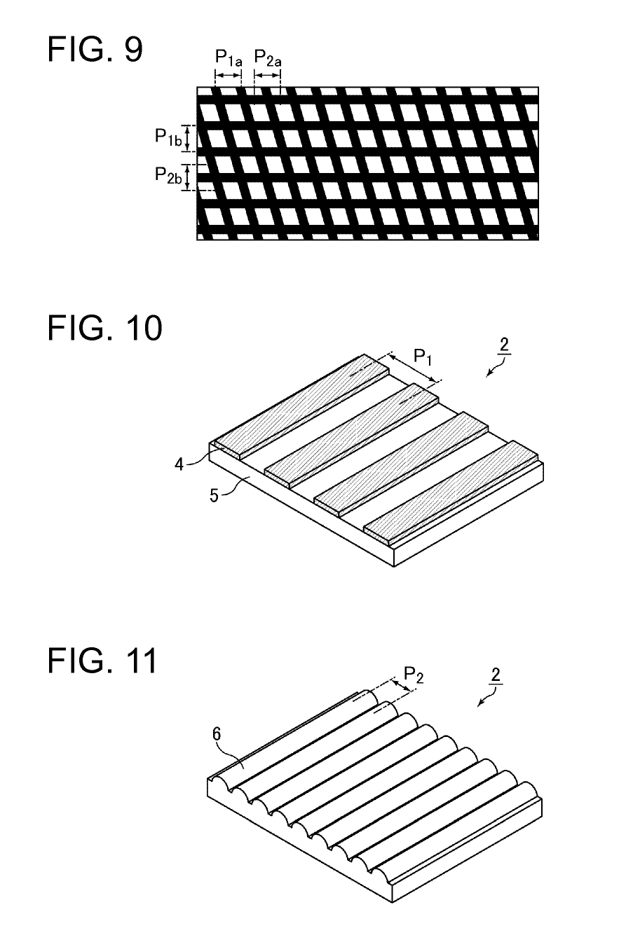

Examples of repeating structures that can be used for the interference sheet include structures that exhibit the following forms when viewed in a plan view: stripe patterns such as those shown in FIGS. 6 and 7, and grid patterns such as those shown in FIGS. 8 and 9. These grid patterns include a plurality of mutually parallel first repeating units and a plurality of mutually parallel second repeating units that intersect the first repeating units. In the mutually parallel repeating units that form the repeating structure, it is preferable that the spacing between each adjacent unit be the same. This is because if the difference in the distances between adjacent units in the repeating structure is too large, the repeating structure will diffuse the light from the backlight unit, which can result in blurring of the image displayed.

The patterns shown in FIGS. 6 to 9 can also be used as the pattern for the plurality of wires in the touch panel 1 or as the pattern for the black matrix in the liquid crystal panel. That is, FIGS. 6 to 9 are also plan views schematically illustrating the plurality of wires of a touch panel that can be used in Embodiment 1. Similarly, FIGS. 6 to 9 are also plan views schematically illustrating the black matrix of a liquid crystal panel that can be used in Embodiment 1. When FIGS. 6 to 9 represent a touch panel, the black areas correspond to wires. When FIGS. 6 to 9 represent a liquid crystal panel, the black areas correspond to the black matrix.

The spacing between adjacent repeating units of the interference sheet 2 will be described below. In case (i), P₁ represents the spacing between the centers of adjacent light-shielding units 4, as shown in FIG. 3. In case (ii), P₂ represents the spacing between the highest points of protrusions 6 and 7, as shown in FIGS. 4 and 5. In plan views of stripe patterns, the spacing P₁ for case (i) and the spacing P₂ for case (ii) are represented by different areas of the plan view, as shown in FIGS. 6 and 7. For grid patterns, the spacing between the centers of adjacent light-shielding units 4 for case (i) can be represented by a first spacing P₁ₐ and/or a second spacing P_{1b}, and the spacing between the highest points of protrusions 6 and 7 for case (ii) can be represented by a first spacing P₂ₐ and/or a second spacing P_{2b}. For grid patterns in case (i), it is preferable that either the first spacing P₁ₐ or the second spacing P_{1b} between the centers of light-shielding units 4 satisfy formula (1), but it is more preferable that both the first spacing P₁ₐ and the second spacing P_{1b} satisfy formula (1). Similarly, for grid patterns in case (ii), it is preferable that either the first spacing P₂ₐ or the second spacing P_{2b} between the highest points of protrusions 6 and 7 satisfy formula (1), but it is more preferable that both the first spacing P₂ₐ and the second spacing P_{2b} satisfy formula (1).

When the interference sheet 2 is used together with a 32-inch 4K2K (4096 pixels×2160 pixels) liquid crystal panel, for example, the actual spacing P₁, P₁ₐ, P_{1b}, P₂, P₂ₐ, and P_{2b} between adjacent repeating units can be 200-300 μm, for example.

Similarly, when the wires of the touch panel 1 form a stripe pattern, the spacing between the centers of adjacent wires can be represented by P₁. When the wires of touch panel 1 form a grid pattern, the spacing between the centers of adjacent wires can be represented by P₁ₐ or P_{1b}. The actual spacing P₁, P₁ₐ, and P_{1b} between adjacent wires in the touch panel 1 can be 300-500 μm, for example.

Similarly, when the black matrix 9 of the display panel 3 forms a stripe pattern, the spacing between the centers of adjacent straight members of the black matrix 9 can be represented by P₁. When the black matrix 9 of the display panel 3 forms a grid pattern, the spacing between the centers of adjacent straight members of the black matrix 9 can be represented by P₁ₐ or P_{1b}. The actual spacing P₁, P₁ₐ, and P_{1b} between adjacent straight members in the black matrix 9 can be 100-200 μm, for example.

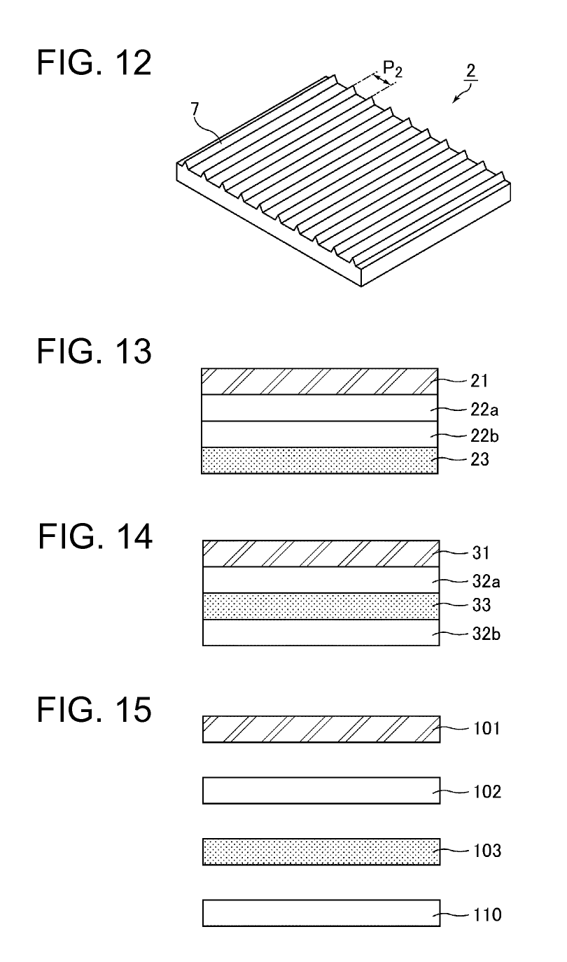

When viewed in perspective, the interference sheet 2 appears as shown in FIGS. 10 to 12. The interference sheet shown in FIG. 10 appears as shown in FIG. 3 when viewed in cross-section and as shown in FIG. 6 when viewed in plan view. The interference sheet shown in FIG. 11 appears as shown in FIG. 4 when viewed in cross-section and as shown in FIG. 6 when viewed in plan view. The interference sheet shown in FIG. 12 appears as shown in FIG. 5 when viewed in cross-section and as shown in FIG. 6 when viewed in plan view.

Examples of the transparent base material include resins having a high transparency such as polyethylene terephthalate (PET) and triacetylcellulose (TAC), as well as glass or the like. Examples of materials for the light-shielding members include metals such as copper (Cu), iron (Fe), titanium (Ti), and aluminum (Al), as well as resins that contain a black pigment, or the like.

The types of interference sheets, black matrices, and touch panel wiring schemes that can be used in Embodiment 1, as well as the characteristics of the repeating structures thereof, are not limited to those described by way of example above. The optimal repeating structure to employ for the interference sheet, black matrix, and touch panel wiring can selected as appropriate on the basis of the moiré patterns, the moiré pitch of these moiré patterns, or other characteristics of the moiré effect caused by the structure of the display device and touch panel.

A method of manufacturing the display device of Embodiment 1 will be described below.

First, the following are prepared: a liquid crystal panel equipped with a black matrix having a plurality of straight members with spacing A between adjacent straight members, and a touch panel having a plurality of wires with spacing B between adjacent wires. Next, a gate driver, source driver, display control circuit, and the like are connected to the liquid crystal panel, and a backlight unit is disposed on the rear surface of the liquid crystal panel.

Next, the actual values for A and B are set, and an interference sheet is selected such that the spacing C between adjacent repeating units of the interference sheet satisfies formula (1) below.

<#2>

A<C<B (1)

Next, the selected interference sheet is inserted between the touch panel and the liquid crystal panel, and whether any moiré patters are visible is confirmed. At this time, arranging the components such that the plurality of straight members of the black matrix, the plurality of wires of the touch panel, and the plurality of repeating units of the repeating structure of the interference sheet are parallel reduces the likelihood that interference patterns will occur, thereby more effectively reducing the visibility of moiré patterns.

If occurrence of the moiré effect is not reduced, another interference sheet that satisfies formula (1) above is inserted, and whether any moiré patters are visible is confirmed again. In this way, a suitable interference sheet can be selected just by replacing the interference sheet and without changing the design of the touch panel and display panel. Viewing a display device in which an interference sheet is actually inserted, as described above, allows the effects of conditions that would be difficult to simulate (such as the curvature of the interference sheet or the width of the gap between the interference sheet and the display panel) to be confirmed.

After reduction of the perceptibility of the moiré effect has been confirmed, the interference sheet selected using the simulation and visual test described above is inserted between the touch panel and the liquid crystal display panel, and assembly of the display device is finished.

If a large gap is left between the display panel and the interference sheet or between the interference sheet and the touch panel during assembly of the display device, the moiré pitch of the moiré patterns will appear to increase or decrease as the display device is viewed from different angles. In order to prevent these types of changes in the appearance of moiré patterns, it is preferable that the gap between the display panel and the interference sheet and the gap between the interference sheet and the touch panel be small (specifically, 100 μm or less), and it is preferable that the display panel, interference sheet, and touch panel be arranged in close contact to one another. The display panel may be or may not be fixed to the interference sheet using an adhesive, screws, or the like, and similarly, the touch panel may be or may not be fixed to the interference sheet using an adhesive, screws, or the like.

Moreover, it is preferable that the interference sheet be connected to an electrical ground. This can block radiation noise from the display device and stabilize operation of the touch panel.

### Embodiment 2

Embodiment 2 is identical to Embodiment 1 except in that the number of interference sheets used is different. In Embodiment 2, two interference sheets 22a and 22b are disposed between a touch panel 21 and a display panel 23, as shown in FIG. 13. These interference sheets 22a and 22b may both have the structure described in the abovementioned case (i) or one interference sheet may have one structure and the other interference sheet may have the other structure described in the abovementioned case (ii), or one of the interference sheets may have the structure from case (i) and the other interference sheet may have one of the structures from case (ii). When inserting a plurality of interference sheets as in the present embodiment, the values of the spacing between adjacent repeating units for each interference sheet may satisfy formula (1). The spacing Ca of interference sheet 22a and the spacing Cb of interference sheet 22b may satisfy A<Cb<Ca<B, for example.

In the display device of Embodiment 2, inserting interference sheets can reduce moiré pitch and visibility of moiré patterns, as in Embodiment 1.

### Embodiment 3

Embodiment 3 is identical to Embodiment 1 except in that the number of interference sheets used and the order in which the components are arranged is different. In Embodiment 3, a touch panel 31, an interference sheet 32a, a display panel 33, and an interference sheet 32b are disposed in this same order from the side from which the display device is viewed to the rear surface of the display device, as shown in FIG. 14. These interference sheets 32a and 32b may both have the structure described in the abovementioned case (i) or one interference sheet may have one structure and the other interference sheet may have the other structure may both have one of the structures described in the abovementioned case (ii), or one of the interference sheets may have the structure from case (i) and the other interference sheet may have one of the structures from case (ii). When inserting one interference sheet above the display panel and one interference sheet below the display panel as in the present embodiment, the values for the spacing between adjacent repeating units for each interference sheet may satisfy formula (1). The spacing Cc of interference sheet 32a and the spacing Cd of interference sheet 32b may satisfy A<Cd<Cc<B, for example.

In the display device of Embodiment 3, inserting interference sheets can reduce moiré pitch and visibility of moiré patterns, as in Embodiment 1.

(Evaluation Test)

An evaluation of occurrence of the moiré effect was performed on a display device having an interference sheet (display device X) and on a display device not having an interference sheet (display device Y).

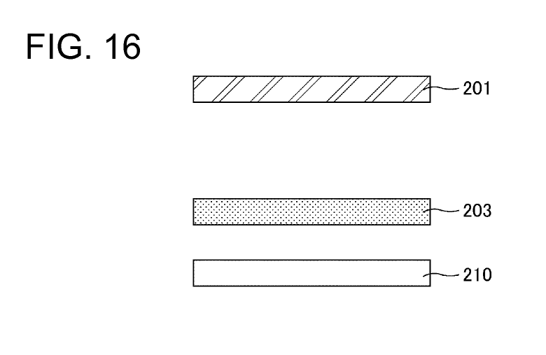

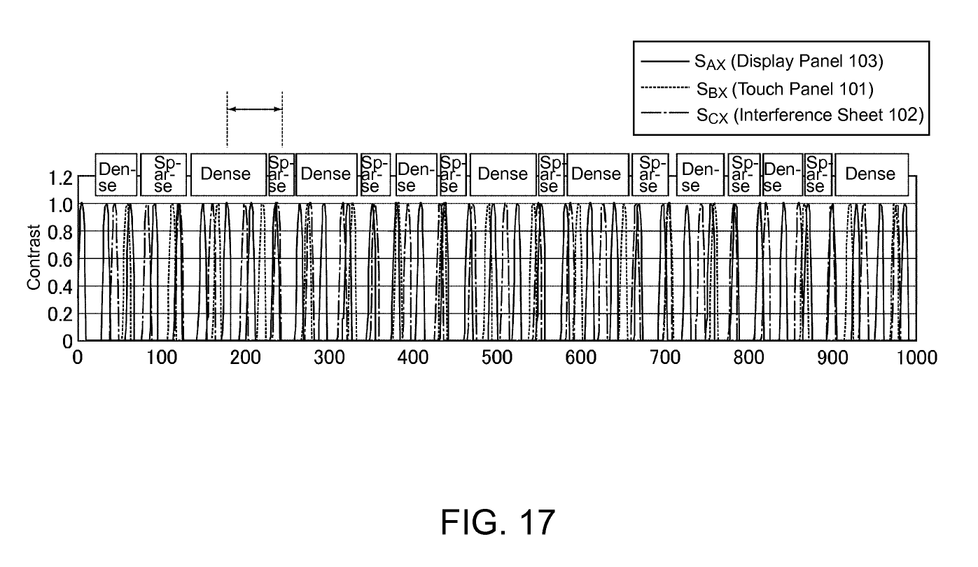

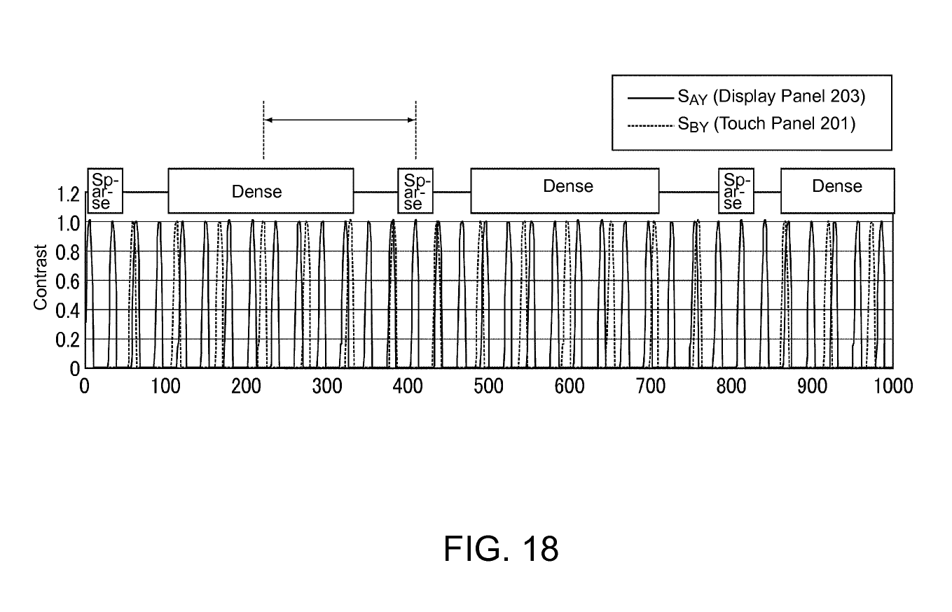

FIGS. 15 and 16 are cross-sectional views schematically illustrating the structures of display devices X and Y, respectively, as envisioned for the simulation. Display device X has a structure in which a touch panel 101, an interference sheet 102, a display panel 103, and a backlight unit 110 are disposed in this same order from the side from which the display device is viewed to the rear surface of the display device, as shown in FIG. 15. Display device Y has a structure in which a touch panel 201, a display panel 203, and a backlight unit 210 are disposed in this same order from the side from which the display device is viewed to the rear surface of the display device, as shown in FIG. 16. FIGS. 17 and 18 are graphs illustrating the results of simulating occurrence of the moiré effect for display devices X and Y, respectively. In FIGS. 17 and 18, the vertical axis represents moiré contrast and the horizontal axis represents distance in the horizontal direction. The bidirectional arrows in FIGS. 17 and 18 represent moiré pitch.

The moiré effect can be simulated by approximating the shadows cast by structures upon receiving light transmitted from the backlight as sine waves.

For display device X, the shadows cast by a plurality of straight members of a black matrix of display panel 103, a plurality of wires in touch panel 101, and a plurality of repeating units of interference sheet 102 upon receiving light transmitted from the backlight unit 110 were each approximated as sine waves and represented as curves S_{AX}, S_{BX}, and S_{CX}, respectively. Then, the waveforms obtained for S_{AX}, S_{BX}, and S_{CX} were superimposed, and the appearance of moiré patterns that would be visible when viewing the screen of display device X was predicted by observing the period of areas of collective curve density. In display device X, the periods of the waves S_{AX}, S_{BX}, and S_{CX} satisfy the relationship S_{AX}<S_{CX}<S_{BX}.

The repeating waveform S_{AX} can be represented by the function f(x)=|sin(a×k₁×−φ₁)| for 0<x<180/(a×k₁)+φ₁ and by the function f(x)=0 for 180/(a×k₁)+φ₁<x<180/(a×k₁)+φ₁+L₁. Here, a is an arbitrary constant, k₁ is the width of a straight member in the black matrix of the display panel, L₁ is the total edge-to-edge distance of the straight members in the black matrix of the display panel, and φ₁ is the error in positioning of the display panel.

The repeating waveform S_{BX} can be represented by the function f(x)=|sin(a×k₂×x−φ₂)| for 0<x<180/(a×k₂)+φ and by the function f(x)=0 for 180/(a×k₂)+φ₂<x<180/(a×k₂)+φ₂+L₂. Here, a is an arbitrary constant, k₂ is the width of a repeating unit of the interference sheet, L₂ is the distance between the edges of adjacent repeating units of the interference sheet, and φ₂ is the error in positioning of the interference sheet.

The repeating waveform S_{CX} can be represented by the function f(x)=|sin(a×k₃x−φ₃)| for 0<x<180/(a×k₃)+φ₃ and by the function f(x)=0 for 180/(a×k₃)+φ₃<x<180/(a×k₃)+φ₃+L₃. Here, a is an arbitrary constant, k₃ is the width of a wire in the touch panel, L₃ is the distance between the edges of adjacent wires in the touch panel, and φ₃ is the error in positioning of the touch panel.

For display device Y, the shadows cast by a plurality of straight members of a black matrix of display panel 203 and by a plurality of wires in touch panel 201 upon receiving light transmitted from the backlight unit 210 were each approximated as sine waves and represented as curves S_{AY} and S_{BY}, respectively. Then, the waveforms obtained for S_{AY} and S_{BY} were superimposed, and the appearance of moiré patterns that would be visible when viewing the screen of display device Y was predicted by observing the period of areas of collective curve density. In display device Y, the periods of the waves S_{AY} and S_{BY} satisfy the relationship S_{AY}<S_{BY}. The curves S_{AY} and S_{BY} were calculated in the same manner as curves S_{AX} and S_{BX} above.

Comparing FIGS. 17 and 18 reveals that for display device Y, which does not have an interference sheet, the areas with sparse and dense collective curve density of curves S_{AY} and S_{BY} appear in a periodic manner and that the period of this phenomenon is large, as shown in FIG. 18. This indicates that the moiré pitch is large and that occurrence of the moiré effect would be easily perceptible to a viewer. Meanwhile, for display device X, which does have an interference sheet, the areas with sparse and dense collective curve density of curves S_{AX}, S_{BX}, and S_{CX} also appear in a periodic manner. However, the period of this phenomenon is smaller than in display device Y. This indicates that the moiré pitch is smaller and that occurrence of the moiré effect would be less perceptible to the viewer in display device X than in display device Y.

These simulation results revealed that inserting an interference sheet for which the periods of the curves S_{AX}, S_{BX}, and S_{CX} satisfy the relationship S_{AX}<S_{CX}<S_{BX} can reduce moiré pitch and the visibility of moiré patterns. The simulations above were performed focusing on (a) the width of a single straight member of the black matrix of the display panel and the distance between the edges of adjacent straight members (b) the width of a single repeating unit of the interference sheet and the distance between the edges of adjacent repeating units, and (c) the width of a single wire in the touch panel and the distance between the edges of adjacent wires. However, occurrence of the moiré effect could also be simulated using the same method if these parameters were instead replaced with the spacing between adjacent straight members in the black matrix of the display panel, the spacing between adjacent wires in the touch panel, and the spacing between adjacent repeating units of the interference sheet. In other words, moiré pitch and the visibility of moiré patterns can be reduced in display device X by inserting an interference sheet that satisfies the relationship A<C<B, where A is the spacing between adjacent straight members in the black matrix of the display panel, B is the spacing between adjacent repeating units of the interference sheet, and C is the spacing between adjacent wires in the touch panel.

### DESCRIPTION OF REFERENCE CHARACTERS

1, 21, 31, 101, 201 touch panel

2, 22a, 22b, 32a, 32b, 102 interference sheet

3, 23, 33, 103, 203 display panel

4 light-shielding member

5 transparent base material

6 protrusion (hemispherical)

7 protrusion (pointed)

8 wire

9 black matrix

110, 210 backlight unit

11, 12 transparent substrate

40 first substrate (color filter substrate)

41 color filter

50 second substrate (array substrate)

60 liquid crystal layer

1. A display device, comprising:
a display panel including a black matrix that has a plurality of straight sections parallel to one another;
a touch panel having a plurality of wiring lines parallel to one another; and
an interference sheet having a plurality of repeating sections parallel to one another,
wherein the interference sheet is disposed between the touch panel and the display panel, and
wherein where A is spacing between adjacent straight sections of the black matrix, B is spacing between adjacent wiring lines of the touch panel, and C is spacing between adjacent repeating sections of the interference sheet.

2. The display device according to claim 1, wherein the plurality of repeating sections of the interference sheet are light-shielding members.

3. The display device according to claim 1, wherein the plurality of repeating sections of the interference sheet are constituted of a transparent base material.

4. The display device according to claim 1, wherein the repeating sections of the interference sheet form a stripe pattern in a plan view.

5. The display device according to claim 1,
wherein the repeating sections of the interference sheet form a grid pattern in a plan view, and
wherein said grid pattern is constituted of the plurality of repeating sections parallel to one another and another plurality of repeating sections parallel to one another and respectively intersecting said plurality of repeating sections.

6. The display device according to claim 2, wherein the repeating sections of the interference sheet form a stripe pattern in a plan view.

7. The display device according to claim 3, wherein the repeating sections of the interference sheet form a stripe pattern in a plan view.

8. The display device according to claim 2,
wherein the repeating sections of the interference sheet form a grid pattern in a plan view, and
wherein said grid pattern is constituted of the plurality of repeating sections parallel to one another and another plurality of repeating sections parallel to one another and respectively intersecting said plurality of repeating sections.

9. The display device according to claim 3,
wherein the repeating sections of the interference sheet form a grid pattern in a plan view, and
wherein said grid pattern is constituted of the plurality of repeating sections parallel to one another and another plurality of repeating sections parallel to one another and respectively intersecting said plurality of repeating sections.
